(19) United States
(12) Patent Application Publication
(10) Pub. No.: US 2026/0329723 A1
(43) Pub. Date: Oct. 22, 2026

(54) REMOTE DEBUGGING METHOD, REMOTE DEBUGGING SYSTEM, DEBUGGING MAINBOARD, ELECTRONIC DEVICE AND COMPUTER STORAGE MEDIUM

(71) Applicant: Beijing Youzhuju Network Technology Co., Ltd., Beijing (CN)

(72) Inventors: Yiwei TANG, Beijing (CN); Huifeng ZHANG, Beijing (CN); Zhixing CHEN, Beijing (CN); Shaopu YAN, Beijing (CN); Shijian GE, Beijing (CN); Lei YU, Beijing (CN); Kairui SHE, Beijing (CN); Yongsu ZHANG, Beijing (CN); Yu ZHANG, Beijing (CN); Jian WANG, Beijing (CN)

(21) Appl. No.: 19/412,197

(22) Filed: Dec. 8, 2025

(30) Foreign Application Priority Data
Apr. 17, 2025 (CN) 202510489104.1

(51) Int. Cl. G06F 11/362

(52) U.S. Cl. CPC G06F 11/362

(57) ABSTRACT

A remote debugging method, a remote debugging system, a debugging mainboard, an electronic device, and a computer storage medium are provided. The method is applied to the debugging mainboard. and includes: a mainboard controller of the debugging mainboard sends an authentication request to the authentication module in response to a remote debugging request for the debugging module, wherein the mainboard controller is configured to debug an execution environment in a debugging state of the debugging module; a authentication module of the debugging mainboard performs encryption verification with an authentication server via the mainboard controller in response to the authentication request; the authentication module performs signature verification on an encryption verification result via the mainboard controller and the authentication server; and the authentication module controls the debugging module to enter the debugging state after the signature verification is passed.

### CROSS REFERENCE

The present disclosure claims to priority to Chinese invention application 202510489104.1 filed on Apr. 17, 2025 titled “REMOTE DEBUGGING METHOD, REMOTE DEBUGGING SYSTEM, DEBUGGING MAINBOARD, ELECTRONIC DEVICE AND COMPUTER STORAGE MEDIUM”, which is in incorporated herein by reference in its entirety.

### TECHNICAL FIELD

Embodiments of the present disclosure relate to the field of computer technologies, and in particular, to a remote debugging method, a remote debugging system, a debugging mainboard, an electronic device, and a computer storage medium.

### BACKGROUND

With the rapid development of information technology, cloud services have been widely used in various fields. Cloud services involve a large amount of data storage, transmission, and processing, which also covers various types of sensitive data, and the data security of cloud services faces many challenges. In the process of data transmission, powerful encryption technologies are required to prevent data from being stolen or tampered with. At the same time, access control for data must also be strictly managed to ensure that only authorized users can access specific data.

As a cloud computing technology, privacy computing isolates sensitive data in a secure area by constructing a Trusted Execution environment (TEE), ensuring data security in the process of data processing. RISC-V TEE (Trusted Execution Environment based on RISC-V) is a trusted execution environment based on the RISC-V architecture. Through software virtualization, the execution environment can be divided into multiple execution domains, and different execution domains run software systems with different security levels.

The debugging function is indispensable in all aspects of device research and development, production, online operation and maintenance, which is conducive to accelerating fault analysis. In the face of the security problem of debugging, the industry basically turns off the debugging function after mass production, and after a problem occurs, the device is sent back to the original factory to turn on the debugging by refreshing the firmware. However, the flexibility of this debugging solution is poor.

### SUMMARY

In view of this, embodiments of the present disclosure provide a remote debugging method, a remote debugging system, a debugging mainboard, an electronic device, and a computer storage medium to solve the above problems.

According to a first aspect of embodiments of the present disclosure, a remote debugging method is provided, which is applied to a debugging mainboard, where the debugging mainboard includes a mainboard controller and a device to be debugged, the device to be debugged includes a debugging module and an authentication module, and the remote debugging method includes: the mainboard controller sends an authentication request to the authentication module in response to a remote debugging request for the debugging module, wherein the mainboard controller is configured to debug an execution environment while the debugging module is in a debugging state; the authentication module performs encryption verification with an authentication server via the mainboard controller in response to the authentication request; the authentication module performs signature verification on a result of the encryption verification via the mainboard controller and the authentication server; and the authentication module controls the debugging module to enter the debugging state after the signature verification is passed.

According to a second aspect of embodiments of the present disclosure, a debugging mainboard is provided, which includes a mainboard controller and a device to be debugged, where the device to be debugged includes a debugging module and an authentication module; the mainboard controller sends an authentication request to the authentication module in response to a remote debugging request for the debugging module, wherein the mainboard controller is configured to debug an execution environment while the debugging module is in a debugging state; and the authentication module perform encryption verification with an authentication server via the mainboard controller in response to the authentication request, performs signature verification on a result of the encryption verification via the mainboard controller and the authentication server, and controls the debugging module to enter the debugging state after the signature verification is passed.

According to a third aspect of embodiments of the present disclosure, a remote debugging system is provided, which includes: the debugging mainboard according to the second aspect, and a debugging apparatus.

According to a fourth aspect of embodiments of the present disclosure, an electronic device is provided, which includes: a processor, a memory, a communication interface, and a communication bus. The processor, the memory, and the communication interface are configured to communicate with each other through the communication bus; the memory is configured to store at least one executable instruction, and the executable instruction causes the processor to perform operations of the device to be debugged or the mainboard controller according to the second aspect.

According to a fifth aspect of embodiments of the present disclosure, a computer storage medium is provided, where a computer program is stored on the computer storage medium, and when the computer program is executed by a processor, the method according to the first aspect is implemented.

In the scheme of the embodiments of the present disclosure, the mainboard controller in the debugging mainboard facilitates implementing forwarding between the debugging module in the device to be debugged and the debugging apparatus, thereby reducing configuration requirements for the debugging apparatus, and can receive a debugging instruction from the debugging apparatus to perform remote debugging on the execution environment, thereby improving flexibility of debugging. In addition, the mainboard controller may also implement forwarding between the authentication server and the authentication module, and through the encryption verification process and the signature verification process, the debugging apparatus is reliably authenticated before the execution environment is remotely debugged through the debugging module.

### BRIEF DESCRIPTION OF THE DRAWINGS

In order to more clearly explain the technical solutions in the embodiments of the present disclosure or in the related art, the following will briefly introduce the drawings that need to be used in the description of the embodiments or the related art. Obviously, the drawings in the following description are only some embodiments recorded in the embodiments of the present disclosure, and for those of ordinary skill in the art, other drawings may also be obtained based on these drawings.

FIG. 1 is a schematic block diagram of a remote debugging system applicable to some embodiments of the present disclosure.

FIG. 2 is a flowchart of steps of a remote debugging method according to some embodiments of the present disclosure.

FIG. 3 is a schematic block diagram of a further example of the remote debugging system of FIG. 1.

FIG. 4 is a flowchart of steps of a remote debugging method of some examples of the embodiment of FIG. 2.

FIG. 5 is a schematic block diagram of a debugging mainboard according to another embodiment of the present disclosure.

FIG. 6 is a schematic structural diagram of an electronic device according to other embodiments of the present disclosure.

### DETAILED DESCRIPTION OF EMBODIMENTS

In order to enable those skilled in the art to better understand the technical solutions in the embodiments of the present disclosure, the technical solutions in the embodiments of the present disclosure will be clearly and completely described below in conjunction with the drawings in the embodiments of the present disclosure. Obviously, the described embodiments are only part of the embodiments of the present disclosure, but not all of them. All other embodiments obtained by persons of ordinary skill in the art based on the embodiments in the embodiments of the present disclosure shall fall within the protection scope of the embodiments of the present disclosure.

The specific implementation of the embodiments of the present disclosure will be further described below in conjunction with the drawings of the embodiments of the present disclosure.

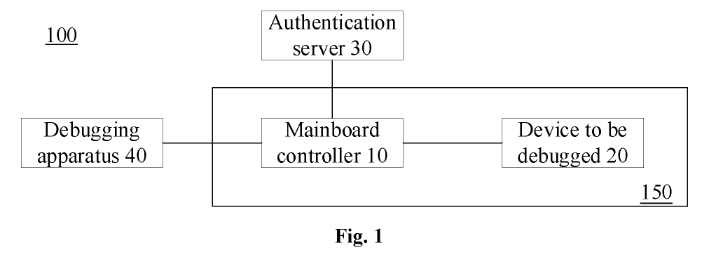

FIG. 1 shows a remote debugging system 100 applicable to some embodiments of the present disclosure. The remote debugging system 100 in FIG. 1 includes a debugging mainboard 150 having a mainboard controller 10 and a device to be debugged 20, a debugging apparatus 40, and an authentication server 30. As a complete debugging architecture, the remote debugging system 100 includes key components for ae debugging process. The debugging mainboard 150 is a core part of the system, which integrates the mainboard controller 10 and the device to be debugged 20. The mainboard controller 10 is used to coordinate and control the debugging process. The mainboard controller 10 is configured to respond to a remote debugging request initiated by the debugging apparatus 40, and further monitor and debug an execution environment such as a Trusted Execution Environment (TEE) during the remote debugging process, so as to ensure the smooth progress of debugging operations. As an object to be debugged, the device to be debugged 20 enters a debugging state under the control of the mainboard controller 10, so that a debugger can perform detailed detection and optimization on the device to be debugged through the debugging apparatus 40. As an external debugging tool or device, the debugging apparatus 40 sends a debugging request to the mainboard controller 10, and interacts with the mainboard controller 10 during the debugging process to obtain debugging data and feedback information. The authentication server 30 is used to perform authentication verification on the debugging request, and through cooperation with the mainboard controller 10 and an authentication module, only an authorized debugging request is allowed to be executed, thereby ensuring security of the system.

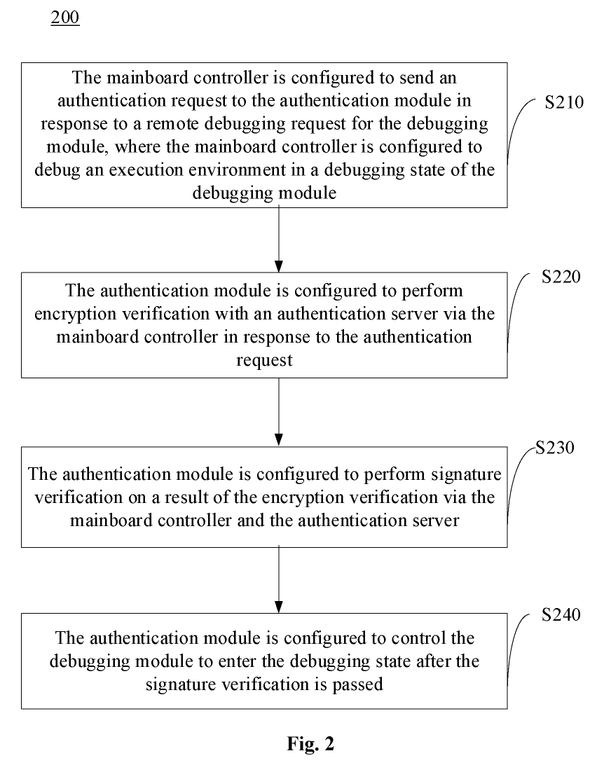

FIG. 2 shows a remote debugging method 200 according to some embodiments of the present disclosure. The remote debugging method 200 may be applied to the debugging mainboard 150 as shown in FIG. 1, and the debugging mainboard 150 may include the mainboard controller 10 and the device to be debugged 20. The device to be debugged 20 includes a debugging module and an authentication module. Specifically, the remote debugging method 200 includes the following steps.

S210: the mainboard controller sends an authentication request to the authentication module in response to a remote debugging request for the debugging module, where the mainboard controller is configured to debug an execution environment in a debugging state of the debugging module.

It should be understood that the remote debugging request may come from an external debugging device or external software as an example of the debugging apparatus, and the remote debugging request may include related information of the debugging module, a domain identifier of the execution domain, user permission information such as a user permission level required for debugging, and the like. When the mainboard controller receives a remote debugging requirement, the mainboard controller responds to the remote debugging request, and sends the authentication request to the authentication module to complete remote debugging authentication. In addition, the authentication request may include related information of the debugging request, so that the authentication module performs a subsequent authentication verification operation according to the related information. In addition, the execution environment in the device to be debugged may be a Trusted Execution Environment, which includes at least one execution domain configured based on a processor core and having different permission levels or security levels. The mainboard controller is configured to control data flow of the execution environment, detect stability of the execution environment, and the like when the debugging module is in the debugging state. That is, in the case that the debugging module is not in the debugging state, the mainboard controller cannot access the execution environment through the debugging module.

S220: the authentication module performs encryption verification with the authentication server via the mainboard controller in response to the authentication request.

It should be understood that after receiving the authentication request from the mainboard controller, the authentication module may initiate a remote debugging authentication process, and the authentication process may include an encryption verification process. Before the encryption verification process, the authentication module may first perform preliminary check on information in the authentication request, for example, whether an authentication format is legal, whether the information in the authentication request is complete, and the like. Then, the authentication module establishes a communication connection with the authentication server via the mainboard controller, and then sends key information to the authentication server in the form of an encrypted message. The encryption algorithm may be a common symmetric encryption or asymmetric encryption algorithm, such as AES, RSA, and the like. After receiving the encrypted message, the authentication server decrypts the encrypted message with a corresponding key to obtain the key information.

S230: the authentication module performs signature verification on an encryption verification result via the mainboard controller and the authentication server.

It should be understood that after completing the decryption operation, the authentication server further verifies the key information, for example, checks user identity information, user permission information, and the like of the remote debugging request, generates a signature based on the key information, and sends back the signature result to the authentication module to perform the signature verification process after the encryption verification. In addition, after receiving the signature result, the authentication module verifies the signature result using a pre-agreed signature algorithm and a public key of the authentication server. If verification is passed, it indicates that the encryption verification result is legal and correct, and is not tampered with in the transmission process; if verification fails, it indicates that there may be a problem with the encryption verification result, for example, the encryption verification result is forged or tampered with.

S240: the authentication module controls the debugging module to enter the debugging state after the signature verification is passed.

It should be understood that after the authentication module verifies the signature result, it may be considered that the remote debugging authentication is passed, and the execution environment is debugged via the debugging module. When the remote debugging authentication is passed, the authentication module may send an instruction to the debugging module to switch from a non-debugging state to the debugging state. For example, configuration of an internal parameter of the debugging module, an open state of an interface, and the like are changed, so that the debugging apparatus can establish a connection with the debugging module through the mainboard controller, and perform remote debugging through the connection, such as code debugging, performance testing, and function verification in the execution environment.

In the scheme of the embodiments of the present disclosure, the mainboard controller in the debugging mainboard facilitates a forwarding operation between the debugging module in the device to be debugged and the debugging apparatus, reduces configuration requirements for the debugging apparatus, and can receive a debugging instruction from the debugging apparatus to perform remote debugging on the execution environment, thereby improving flexibility of debugging. In addition, the mainboard controller may also implement forwarding between the authentication server and the authentication module, and through the encryption verification process and the signature verification process, the debugging apparatus is reliably authenticated before the execution environment is remotely debugged through the debugging module.

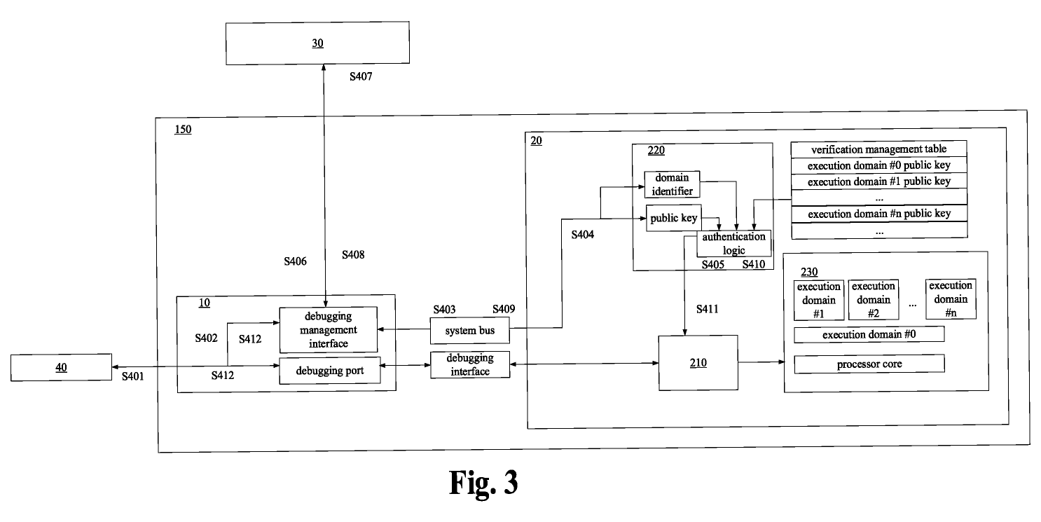

In some embodiments, as shown in FIG. 3, the remote debugging is executed after the remote debugging authentication is passed, and the remote debugging authentication process is completed according to communication interaction among the debugging apparatus 40, the debugging mainboard 150, and the authentication server 30. The debugging mainboard 150 includes the mainboard controller 10 and the device to be debugged 20, and the device to be debugged 20 includes a debugging module 210, an authentication module 220, and an execution environment 230. For example, the remote debugging authentication process may include an encryption verification process and a signature verification process, which are implemented by authentication logic in the authentication module 220. The authentication logic may also maintain a verification management table including an encryption verification management table and a signature verification management table, and execute a calculation process related to encryption or signature by querying the verification management table.

Further, the verification management table indicates a correspondence between each execution domain and each public key, for example, each item of the verification management table indicates a correspondence between a domain identifier of each execution domain (for example, execution domain #0, execution domain #1, ..., execution domain #n) and each public key. That is, each item of the encryption verification management table indicates a correspondence between the domain identifier of each execution domain and a corresponding first public key; each item of the signature verification management table indicates a correspondence between the domain identifier of each execution domain and a corresponding second public key.

Further, the execution environment 230 includes a processor and its register configuration, and multiple execution domains are formed by at least one processor core included in the processor and its corresponding register configuration. The register configuration includes but is not limited to M mode (Machine Mode), S mode (Supervisor Mode), and U mode (User Mode), and the like, where the M mode has full access to hardware resources, and a permission requirement of the M mode is higher than that of the S mode. The permission requirement of the S mode is higher than that of the U mode. Without loss of generality, any execution domain belongs to one of the M mode, the S mode, or the U mode.

For example, the execution domain #0 belongs to the M mode, and the execution domain #1 to the execution domain #n belong to the S mode, the U mode, or the like. Specifically, the M mode is used to initialize the processor and the system, handle exceptions and interrupts, and provide an environment for the operation of the operating system kernel, and is usually used to run firmware (such as BIOS or UEFI) and the operating system kernel. For example, the permission of the M mode may access all hardware resources including a memory, an I/O device, and the like. The S mode is usually used to run the operating system kernel, provide an operating environment for a user mode (U mode) program, and manage virtual memory and memory protection. For example, the S mode is used to isolate user programs and protect system resources in a multi-user operating system. The U mode is used to run a general user program, and requests the operating system kernel (S mode) or firmware (M mode) to provide a service through a system call (such as an ecall instruction). For example, an application in a user space usually runs in the U mode to protect system resources and isolate user programs.

Specifically, in the encryption verification process, in order to perform encryption verification with the authentication server 30 via the mainboard controller 10 in response to the authentication request, the authentication request may be parsed to obtain the user permission information, then a first random number is generated when the user permission information meets an authentication condition, and the first random number is encrypted with a first public key in a first key pair to obtain an encrypted response message, and then the encrypted response message is sent to the authentication server 30 via the mainboard controller 10, so that the authentication server decrypts the encrypted response message with a first private key in the first key pair.

That is, the encryption verification is performed between the authentication server and the authentication module using the agreed first key pair, which improves the reliability of the encryption verification. In addition, the user permission information is used as a judgment condition for performing the encryption verification, which further ensures the security of the remote debugging authentication.

Further, in the encryption verification process, in order to perform encryption verification with the authentication server via the mainboard controller in response to the authentication request, the encryption verification management table may be acquired, and then, a public key corresponding to the user permission information is determined as the first public key according to the encryption verification management table. It should be understood that the encryption verification management table indicates a correspondence between each user permission information and each public key.

Further, in the signature verification process, in order to perform signature verification on the encryption verification result via the mainboard controller and the authentication server, a signature response message may be acquired from the authentication server via the mainboard controller, then the signature response message is decrypted with a second public key in a second key pair to obtain a second random number, and then whether the first random number matches the second random number is determined. It should be understood that the signature response message is obtained by encrypting the second random number with a second private key in the second key pair. That is, the signature verification is performed between the authentication server and the authentication module using the agreed second key pair, which improves the reliability of the signature verification.

Further, as an example of determining whether the signature verification is passed, it may be determined that the signature verification is passed when the first random number matches the second random number, and it is determined that the signature verification fails when the first random number does not match the second random number.

In the signature verification process, in order to perform signature verification on the encryption verification result via the mainboard controller and the authentication server, the signature verification management table may be acquired, and then, a public key corresponding to the user permission information is determined as the second public key according to the signature verification management table. It should be understood that the signature verification management table indicates a correspondence between each user permission information and each public key, and different user permission information corresponds to different second key pairs, which further improves the security of the signature verification process.

In addition, when the debugging module is controlled to enter the debugging state after the signature verification is passed, a debugging enable signal may be sent to the debugging module when the first random number matches the second random number, where the debugging enable signal indicates that the debugging module enables a debugging interface of the mainboard controller.

That is, the first random number and the second random number ensure that the signature verification is performed when the encryption verification is passed, which further improves the reliability of the remote debugging authentication, so that when the remote debugging authentication is passed, the debugging module enters the debugging state through the debugging enable signal, which is compatible with the control logic of the debugging module.

Further, in the encryption verification process, in order to encrypt the first random number with the first public key in the first key pair to obtain the encrypted response message, at least one execution domain in the execution environment that satisfies the user permission information may be determined, and then the first random number and a domain identifier of the at least one execution domain are encrypted with the first public key in the first key pair to obtain the encrypted response message.

That is, the user permission information may authorize at least one execution domain that satisfies the user permission information, so that the debugging apparatus can access the at least one authorized execution domain, and the debugging apparatus cannot access an execution domain that does not satisfy the user permission information.

That is, the encryption verification management table indicates a correspondence between each user permission information and each public key, and different user permission information corresponds to different first key pairs, which further improves the security of the encryption verification process.

Further, in order to make the debugging authentication process more reliable, the authentication module may determine a first time stamp of a first time when the encryption verification is performed, and determine a second time stamp of a second time when the encryption verification result is obtained.

In the case that the time difference between the second time stamp and the first time stamp is less than the preset duration, the authentication module may start to perform signature verification.

That is, the preset duration is used as a judgment condition for an interval duration between the encryption verification process and the signature verification process, and the time difference between the second time stamp and the second time stamp may be accurately divided, so that when the time difference is less than the preset duration, the remote debugging authentication including the encryption verification process and the signature verification process is ensured to be more reliable. In other words, in the case that the time difference is less than the preset duration, it indicates that the reliability of the signature verification process is relatively high, so that comparison between the first random number and the second random number may be further performed.

Alternatively, in the case that the time difference between the second time stamp and the first time stamp is greater than the preset duration, the authentication module may abandon execution of the signature verification. That is, in the case that the time difference is greater than the preset duration, it indicates that the reliability of the signature verification process has been significantly deteriorated, so that there is no need to further perform the comparison between the first random number and the second random number, and the execution of the signature verification is abandoned, so that the encryption verification process is re-executed.

Furthermore, as an example of determining the first time stamp of the first time when the encryption verification is performed, a first time when the first random number for encryption verification is generated may be determined, and timing monitoring is performed from the first time with the preset duration.

Correspondingly, as an example of determining the second time stamp of the second time when the encryption verification result is obtained, a second time when the second random number for signature verification is received may be determined, where the second random number indicates that the encryption verification of the first random number is passed. Correspondingly, when the second random number for signature verification is received, if the preset duration is not reached, the time difference between the second time stamp and the first time stamp is less than the preset duration, and the authentication module starts to perform signature verification.

Correspondingly, when the preset duration is reached, if the second random number is not received, the time difference between the second time stamp and the first time stamp is greater than the preset duration, and the authentication module abandons execution of the signature verification.

That is, timing monitoring of the preset duration is performed from the first time when the first random number for encryption verification is generated, and the reliability of the signature verification process is ensured through simple configuration.

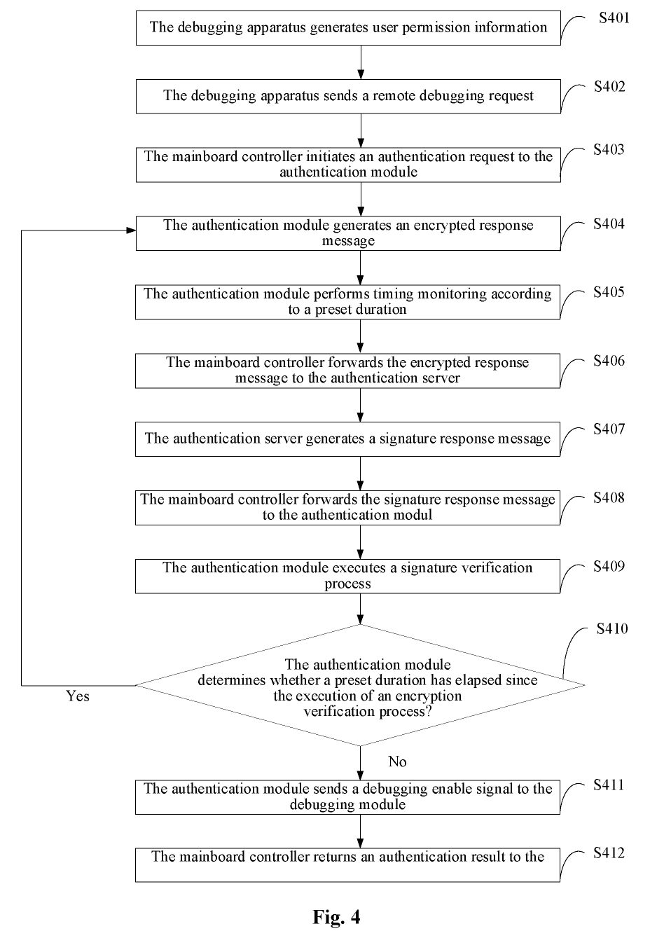

A remote debugging authentication process of some examples of the embodiment in FIG. 2 will be described in detail below with reference to FIG. 4. The remote debugging method 400 in FIG. 4 corresponds to the remote debugging system in FIG. 3, and includes:

Step S401: the debugging apparatus generates user permission information. It should be understood that a debugging user may open debugging software on one side of the debugging apparatus 40 to input an IP of the mainboard controller, a user name and a password, and user permission to log in to the debugging software.

Step S402: the debugging apparatus sends a remote debugging request. It should be understood that the debugging apparatus 40 initiates a remote debugging request to the mainboard controller 10 through a network. For example, the remote debugging request may be sent through a network connection with the mainboard controller 10.

Step S403: the mainboard controller initiates an authentication request to the authentication module. It should be understood that after receiving the remote debugging request, the mainboard controller initiates an authentication request to the authentication module through a communication bus. For example, the mainboard controller 10 may include at least a debugging management interface and a debugging interface, where the debugging interface such as an Open On-Chip Debugger (OpenOCD) may be connected to the device to be debugged 20 through a debugging port such as a JTAG debugging probe, so that the mainboard controller 10 accesses the debugging module 210 in the device to be debugged 20 through the debugging port when the authentication result indicates that the authentication is passed. In addition, the debugging management interface may be connected to the device to be debugged through a system bus such as a System Management Bus (SMBus), so that the mainboard controller 10 accesses the authentication module 220 through the debugging management interface when the authentication result indicates that the authentication fails.

Step S404: the authentication module generates an encrypted response message. It should be understood that when initiating the signature verification process, the authentication module may first generate a first random number with a random number generator provided in the authentication module, and record a first time stamp at the same time, then according to the user permission information forwarded by the mainboard controller, encrypt the first random number with a first public key corresponding to the user permission information, and append a domain identifier (ID) of an execution domain to generate encrypted response information, and send the encrypted response information to the mainboard controller. It should be understood that the first public key or the first key pair where the first public key is located corresponds to the user permission information, and the user permission information may also correspond to at least one execution domain in the execution environment, that is, the at least one execution domain that satisfies the user permission information may be remotely debugged by a debugging instruction with the user permission information. For example, the authentication module may execute authentication logic and maintain a verification management table (for example, an encryption verification management table and/or a signature verification management table). Specifically, the authentication logic indicates acquiring the domain identifier of the at least one execution domain, and querying the verification management table to obtain a corresponding public key, for example, querying the encryption verification management table to obtain the first public key, or querying the signature verification management table to obtain the second public key.

Step S405: the authentication module performs timing monitoring according to a preset duration. It should be understood that the authentication module generates a time stamp of a first time of the first random number, and performs timing monitoring according to the preset duration, for example, sets a timeout period based on the preset duration, and if the preset duration is exceeded, subsequent signature verification processes are all invalid, and the encryption verification is re-executed.

Step S406: the mainboard controller forwards the encrypted response message to the authentication server.

Step S407: the authentication server generates a signature response message. It should be understood that the authentication server decrypts the encrypted response message with a first private key in a first key pair indicated by an asymmetric algorithm to obtain the first random number. For example, a corresponding first private key may be selected according to the domain ID of the execution domain, the user name, the password, and the user permission information.

Step S408: the authentication server sends the signature response message. It should be understood that the authentication server may use the first random number in step S404 as a second random number, and after signing with a second private key in a second key pair indicated by the asymmetric algorithm, send the second random number to the mainboard controller.

Step S409: the mainboard controller forwards the signature response message to the authentication module.

Step S410: the authentication module determines whether the preset duration has elapsed since the execution of the encryption verification process, if yes, step S404 is executed, and if no, the signature verification process is executed. If the preset duration is exceeded, the subsequent signature verification processes are all invalid, and the encryption verification is re-executed. When executing the signature verification process, the authentication module decrypts the second random number from the signature response message, and compares the second random number with the first random number, and if they match, the remote debugging authentication is successful.

Step S411: the authentication module sends a debugging enable signal to the debugging module. It should be understood that the authentication module may also send the authentication result to the mainboard controller. The debugging enable signal indicates that the debugging module enables a debugging interface of the mainboard controller.

Step S412: the mainboard controller returns the authentication result to the debugging apparatus. It should be understood that in the case that the authentication is passed, the user may start the remote debugging process through the debugging apparatus. For example, the debugging apparatus sends a debugging instruction to the execution environment through the mainboard controller and then via the debugging module.

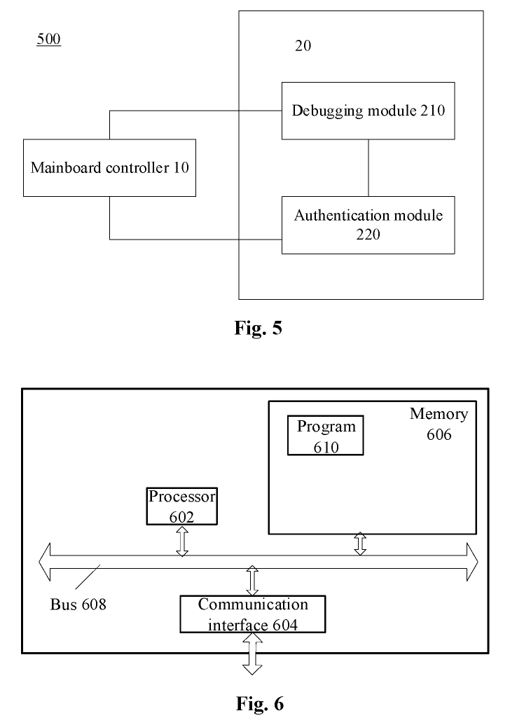

A debugging mainboard according to another embodiment of the present disclosure is described below with reference to FIG. 5. The debugging mainboard 500 in FIG. 5 includes a mainboard controller 10 and a device to be debugged 20, and the device to be debugged 20 includes a debugging module 210 and an authentication module 220.

In addition, the mainboard controller 10 sends an authentication request to the authentication module 220 in response to a remote debugging request for the debugging module 210, where the mainboard controller 10 is configured to debug an execution environment in a debugging state of the debugging module 210;

In addition, the authentication module 220 performs encryption verification with an authentication server via the mainboard controller 10 in response to the authentication request, performs signature verification on an encryption verification result via the mainboard controller 10 and the authentication server, and controls the debugging module 210 to enter the debugging state after the signature verification is passed.

In the scheme of the embodiments of the present disclosure, the mainboard controller in the debugging mainboard facilitates a forwarding operation between the debugging module in the device to be debugged and the debugging apparatus, reduces configuration requirements for the debugging apparatus, and can receive a debugging instruction from the debugging apparatus to perform remote debugging on the execution environment, thereby improving flexibility of debugging. In addition, the mainboard controller may also implement forwarding between the authentication server and the authentication module, and through the encryption verification process and the signature verification process, the debugging apparatus is reliably authenticated before the execution environment is remotely debugged through the debugging module.

In other embodiments, the authentication module is further configured to: parse the authentication request to obtain user permission information; generate a first random number when the user permission information meets an authentication condition, and encrypt the first random number with a first public key in a first key pair to obtain an encrypted response message; send the encrypted response message to the authentication server via the mainboard controller, so that the authentication server decrypts the encrypted response message with a first private key in the first key pair.

In other embodiments, the authentication module is further configured to: acquire a signature response message from the authentication server via the mainboard controller, where the signature response message is obtained by encrypting a second random number with a second private key in a second key pair; decrypt the signature response message with a second public key in the second key pair to obtain the second random number; determine whether the first random number matches the second random number.

In other embodiments, the authentication module is further configured to: send a debugging enable signal to the debugging module when the first random number matches the second random number, where the debugging enable signal indicates that the debugging module enables a debugging interface of the mainboard controller.

In other embodiments, the authentication module is further configured to: determine at least one execution domain in the execution environment that satisfies the user permission information; and encrypt the first random number and a domain identifier of the at least one execution domain with the first public key in the first key pair to obtain the encrypted response message.

In other embodiments, the authentication module is further configured to: acquire an encryption verification management table, where the encryption verification management table indicates a correspondence between each user permission information and each public key; and determine, a public key corresponding to the user permission information as the first public key according to the encryption verification management table.

In other embodiments, the authentication module is further configured to: acquire a signature verification management table, where the signature verification management table indicates a correspondence between each user permission information and each public key; and determine, a public key corresponding to the user permission information as the second public key according to the signature verification management table.

In other embodiments, the authentication module is further configured to: determine a first time stamp of a first time when the encryption verification is performed, and determine a second time stamp of a second time when the encryption verification result is obtained; if a time difference between the second time stamp and the first time stamp is less than a preset duration, start to perform signature verification; if the time difference between the second time stamp and the first time stamp is greater than the preset duration, abandon execution of the signature verification.

In other embodiments, the authentication module is further configured to: determine a first time when the first random number for encryption verification is generated, and perform timing monitoring from the first time with the preset duration; determine a second time when the second random number for signature verification is received, where the second random number indicates that the encryption verification of the first random number is passed; when the second random number for signature verification is received, if the preset duration is not reached, the authentication module starts to perform signature verification; when the preset duration is reached, if the second random number is not received, the authentication module abandons execution of the signature verification.

It should be understood that for the specific implementation of each module in the debugging mainboard, reference may be made to the description corresponding to the corresponding step in the foregoing method embodiment, and the module has corresponding beneficial effects, which will not be repeated herein. Those skilled in the art may clearly understand that, for the convenience and simplicity of description, for the specific working process of the apparatus and modules described above, reference may be made to the description of the corresponding process in the foregoing method embodiment, and details are not repeated herein.

Referring to FIG. 6, a schematic structural diagram of an electronic device according to another embodiment of the present disclosure is shown. The specific embodiment of the present disclosure does not limit the specific implementation of the electronic device.

As shown in FIG. 6, the electronic device may include: a processor 602 for executing a program 610, a communications interface 604, a memory 606, and a communication bus 608.

The processor, the communication interface, and the memory communicate with each other through the communication bus.

The communication interface is configured to communicate with other electronic devices or servers.

The processor is configured to execute the program, and specifically may execute the relevant steps in the foregoing method embodiment.

Specifically, the program may include program code, and the program code includes computer operation instructions.

The processor may be a CPU, or a specific Application Specific Integrated Circuit (ASIC), or one or more integrated circuits configured to implement embodiments of the present disclosure. The one or more processors included in the smart device may be the same type of processor, such as one or more CPUs, or different types of processors, such as one or more CPUs and one or more ASICs.

The memory is configured to store the program. The memory may include a high-speed RAM memory, or may also include a non-volatile memory, such as at least one magnetic disk memory.

The program may include multiple computer instructions, and the program may specifically cause the processor to perform operations of the device to be debugged and the mainboard controller through the multiple computer instructions.

For the specific implementation of each step in the program, reference may be made to the description corresponding to the corresponding step, module or unit in the foregoing method embodiment, and the step has corresponding beneficial effects, which will not be repeated herein. Those skilled in the art may clearly understand that, for the convenience and simplicity of description, for the specific working process of the apparatus, device or module described above, reference may be made to the description of the corresponding process in the foregoing method embodiment, and details are not repeated herein.

An embodiment of the present disclosure further provides a computer storage medium having a computer program stored thereon, where when the computer program is executed by a processor, the method described in any one of the multiple foregoing method embodiments is implemented. The computer storage medium includes but is not limited to: a Compact Disc Read-Only Memory (CD-ROM), a Random Access Memory (RAM), a floppy disk, a hard disk, a magneto-optical disc, etc.

An embodiment of the present disclosure further provides a computer program product, including computer instructions, where the computer instructions instruct a computing device to perform operations of the device to be debugged and the mainboard controller, that is, the mainboard controller sends an authentication request to the authentication module in response to a remote debugging request for the debugging module, where the mainboard controller is configured to debug an execution environment in a debugging state of the debugging module; the authentication module performs encryption verification with an authentication server via the mainboard controller in response to the authentication request; the authentication module performs signature verification on an encryption verification result via the mainboard controller and the authentication server; and the authentication module controls the debugging module to enter the debugging state after the signature verification is passed.

In addition, it should be noted that the user-related information (including but not limited to user device information, user personal information, etc.) and data (including but not limited to sample data for training a model, data for analysis, stored data, displayed data, etc.) involved in the embodiments of the present disclosure are all information and data authorized by the user or fully authorized by all parties, and the collection, use, and processing of the relevant data need to comply with relevant regulations and standards, and a corresponding operation entry is provided for the user to choose to authorize or reject.

It should be pointed out that, according to implementation needs, various components/steps described in the embodiments of the present disclosure may be split into more components/steps, or two or more components/steps or part of operations of the components/steps may be combined into new components/steps to achieve the objectives of the embodiments of the present disclosure.

The foregoing method according to the embodiments of the present disclosure may be implemented in hardware and firmware, or implemented as software or computer code that may be stored in a recording medium (such as a CD-ROM, a RAM, a floppy disk, a hard disk, or a magneto-optical disc), or implemented as computer code originally stored in a remote recording medium or a non-transitory machine-readable medium and to be stored in a local recording medium downloaded through a network, so that the method described herein may be processed by such software stored on a recording medium using a general-purpose computer, a dedicated processor, or programmable or dedicated hardware (such as an Application Specific Integrated Circuit (ASIC) or a Field Programmable Gate Array (FPGA)). It may be understood that the computer, the processor, the microprocessor controller, or the programmable hardware includes a storage component (for example, a Random Access Memory (RAM), a Read-Only Memory (ROM), a flash memory, etc.) that may store or receive software or computer code, and when the software or computer code is accessed and executed by the computer, the processor, or the hardware, the method described herein is implemented. In addition, when a general-purpose computer accesses the code for implementing the method shown herein, the execution of the code converts the general-purpose computer into a dedicated computer for executing the method shown herein.

Those of ordinary skill in the art may realize that the units and method steps of various examples described in conjunction with the embodiments disclosed herein may be implemented in electronic hardware or a combination of computer software and electronic hardware. Whether these functions are performed in hardware or software depends on the specific application and design constraints of the technical solution. Professionals may implement the described functions by using different methods for each particular application, but such implementation should not be considered as going beyond the scope of the embodiments of the present disclosure.

The foregoing implementations are only used to illustrate the embodiments of the present disclosure, and are not intended to limit the embodiments of the present disclosure. Persons of ordinary skill in the related technical field may make various changes and variations without departing from the spirit and scope of the embodiments of the present disclosure. Therefore, all equivalent technical solutions also belong to the scope of the embodiments of the present disclosure, and the patent protection scope of the embodiments of the present disclosure shall be defined by the claims.

1. A remote debugging method, applied to a debugging mainboard, wherein the debugging mainboard comprises a mainboard controller and a device to be debugged, the device to be debugged comprises a debugging module and an authentication module, and the remote debugging method comprises:
sending, by the mainboard controller, an authentication request to the authentication module in response to a remote debugging request for the debugging module, wherein the mainboard controller is configured to debug an execution environment when the debugging module is in a debugging state;
performing, by the authentication module, encryption verification with an authentication server via the mainboard controller in response to the authentication request;
performing, by the authentication module, signature verification on a result of the encryption verification via the mainboard controller and the authentication server; and
controlling, by the authentication module, the debugging module to enter the debugging state after the signature verification is passed.

2. The method of claim 1, wherein performing encryption verification with the authentication server via the mainboard controller in response to the authentication request comprises:
parsing the authentication request to obtain user permission information;
generating a first random number when the user permission information meets an authentication condition, and encrypting the first random number with a first public key in a first key pair to obtain an encrypted response message; and
sending the encrypted response message to the authentication server via the mainboard controller, so that the authentication server decrypts the encrypted response message with a first private key in the first key pair.

3. The method of claim 2, wherein performing signature verification on the result of the encryption verification via the mainboard controller and the authentication server comprises:
acquiring a signature response message from the authentication server via the mainboard controller, wherein the signature response message is obtained by encrypting a second random number with a second private key in a second key pair;
decrypting the signature response message with a second public key in the second key pair to obtain the second random number; and
determining whether the first random number matches the second random number.

4. The method of claim 3, wherein controlling the debugging module to enter the debugging state after the signature verification is passed comprises:
sending a debugging enable signal to the debugging module when the first random number matches the second random number, wherein the debugging enable signal indicates that the debugging module enables a debugging interface of the mainboard controller.

5. The method of claim 2, wherein encrypting the first random number with the first public key in the first key pair to obtain the encrypted response message comprises:
determining at least one execution domain in the execution environment that satisfies the user permission information; and
encrypting the first random number and a domain identifier of the at least one execution domain with the first public key in the first key pair to obtain the encrypted response message.

6. The method of claim 2, wherein performing encryption verification with the authentication server via the mainboard controller in response to the authentication request further comprises:
acquiring an encryption verification management table, wherein the encryption verification management table indicates a correspondence between each user permission information and each public key; and
determining, according to the encryption verification management table, a public key corresponding to the user permission information as the first public key.

7. The method of claim 3, wherein performing signature verification on the result of the encryption verification via the mainboard controller and the authentication server further comprises:
acquiring a signature verification management table, wherein the signature verification management table indicates a correspondence between each user permission information and each public key; and
determining, according to the signature verification management table, a public key corresponding to the user permission information as the second public key.

8. The method of claim 1, wherein the method further comprises:
determining, by the authentication module, a first time stamp of a first time when the encryption verification is performed, and determining, by the authentication module, a second time stamp of a second time when the result of the encryption verification is obtained;
starting to perform signature verification by the authentication module when a time difference between the second time stamp and the first time stamp is less than a preset duration; and
abandoning execution of the signature verification by the authentication module when the time difference between the second time stamp and the first time stamp is greater than the preset duration.

9. The method of claim 8, wherein determining the first time stamp of the first time when the encryption verification is performed comprises: determining a first time when the first random number for encryption verification is generated, and performing timing monitoring from the first time with the preset duration;
wherein determining the second time stamp of the second time when the result of the encryption verification is obtained comprises: determining a second time when the second random number for signature verification is received, wherein the second random number indicates that the encryption verification of the first random number is passed;
wherein the starting to perform signature verification by the authentication module when the time difference between the second time stamp and the first time stamp is less than the preset duration comprises: when the second random number for signature verification is received, if the preset duration is not reached, the authentication module starts to perform signature verification; and
wherein the abandoning execution of the signature verification by the authentication module when the time difference between the second time stamp and the first time stamp is greater than the preset duration comprises: when the preset duration is reached, if the second random number is not received, abandoning the execution of the signature verification by the authentication module.

10. A debugging mainboard, comprising a mainboard controller and a device to be debugged, wherein the device to be debugged comprises a debugging module and an authentication module,
the mainboard controller is configured to send an authentication request to the authentication module in response to a remote debugging request for the debugging module, wherein the mainboard controller is configured to debug an execution environment when the debugging module is in a debugging state; and
the authentication module is configured to perform encryption verification with an authentication server via the mainboard controller in response to the authentication request, performs signature verification on a result of the encryption verification via the mainboard controller and the authentication server, and control the debugging module to enter the debugging state after the signature verification is passed.

11. A remote debugging system, comprising: the debugging mainboard of claim 10, and a debugging apparatus.

12. An electronic device, comprising: a processor, a memory, a communication interface, and a communication bus, wherein the processor, the memory, and the communication interface are configured to communicate with each other through the communication bus;
the memory is configured to store at least one executable instruction, and the executable instruction causes the processor to perform a remote debugging method, applied to a debugging mainboard, wherein the debugging mainboard comprises a mainboard controller and a device to be debugged, the device to be debugged comprises a debugging module and an authentication module, and the remote debugging method comprises:
sending, by the mainboard controller, an authentication request to the authentication module in response to a remote debugging request for the debugging module, wherein the mainboard controller is configured to debug an execution environment when the debugging module is in a debugging state;
performing, by the authentication module, encryption verification with an authentication server via the mainboard controller in response to the authentication request;
performing, by the authentication module, signature verification on a result of the encryption verification via the mainboard controller and the authentication server; and
controlling, by the authentication module, the debugging module to enter the debugging state after the signature verification is passed.

13. The electronic device of claim 12, wherein performing encryption verification with the authentication server via the mainboard controller in response to the authentication request comprises:
parsing the authentication request to obtain user permission information;
generating a first random number when the user permission information meets an authentication condition, and encrypting the first random number with a first public key in a first key pair to obtain an encrypted response message; and
sending the encrypted response message to the authentication server via the mainboard controller, so that the authentication server decrypts the encrypted response message with a first private key in the first key pair.

14. The electronic device of claim 13, wherein performing signature verification on the result of the encryption verification via the mainboard controller and the authentication server comprises:
acquiring a signature response message from the authentication server via the mainboard controller, wherein the signature response message is obtained by encrypting a second random number with a second private key in a second key pair;
decrypting the signature response message with a second public key in the second key pair to obtain the second random number; and
determining whether the first random number matches the second random number.

15. The electronic device of claim 14, wherein controlling the debugging module to enter the debugging state after the signature verification is passed comprises:
sending a debugging enable signal to the debugging module when the first random number matches the second random number, wherein the debugging enable signal indicates that the debugging module enables a debugging interface of the mainboard controller.

16. The electronic device of claim 13, wherein encrypting the first random number with the first public key in the first key pair to obtain the encrypted response message comprises:
determining at least one execution domain in the execution environment that satisfies the user permission information; and
encrypting the first random number and a domain identifier of the at least one execution domain with the first public key in the first key pair to obtain the encrypted response message.

17. The electronic device of claim 13, wherein performing encryption verification with the authentication server via the mainboard controller in response to the authentication request further comprises:
acquiring an encryption verification management table, wherein the encryption verification management table indicates a correspondence between each user permission information and each public key; and
determining, according to the encryption verification management table, a public key corresponding to the user permission information as the first public key.

18. The electronic device of claim 14, wherein performing signature verification on the result of the encryption verification via the mainboard controller and the authentication server further comprises:
acquiring a signature verification management table, wherein the signature verification management table indicates a correspondence between each user permission information and each public key; and
determining, according to the signature verification management table, a public key corresponding to the user permission information as the second public key.

19. The electronic device of claim 12, wherein
the authentication module is further configured to determine a first time stamp of a first time when the encryption verification is performed, and determine a second time stamp of a second time when the result of the encryption verification is obtained;
the authentication module is further configured to start to perform signature verification when a time difference between the second time stamp and the first time stamp is less than a preset duration; and abandon execution of the signature verification when the time difference between the second time stamp and the first time stamp is greater than the preset duration.

20. A non-transitory computer storage medium, wherein a computer program is stored on the computer storage medium, and when the computer program is executed by a processor, operations of the device to be debugged or the mainboard controller of claim 10 are implemented.
